(19) United States
(12) Patent Application Publication
(10) Pub. No.: US 2002/0029641 A1
(43) Pub. Date: Mar. 14, 2002

(54) Metering means for fuel pumps

(76) Inventor: Bengt I. Larsson, Skivarp (SE)

Correspondence Address: JENKENS & GILCHRIST, PC, 1445 ROSS AVENUE, SUITE 3200, DALLAS, TX, 75202, US

(21) Appl. No.: 09/912,038

(22) Filed: Jul. 24, 2001

Related U.S. Application Data
(63) Continuation of application No. PCT/SE00/00126, filed on Jan. 21, 2000.

(30) Foreign Application Priority Data
Jan. 28, 1999 (SE) 9900263.6

(51) Int. Cl. G01F 1/00

(52) U.S. Cl. 73/861

(57) ABSTRACT

A fuel pump unit (1) for dispensing fuel comprises a fuel container (2), a fuel conduit (4) connected to the fuel container (2), and a metering means (11) which is arranged in the conduit (4) to measure a flow of fuel therethrough. The metering means (11) comprises a first metering unit (14) to measure the flow of fuel within a first flow range, and a second metering unit (12) to measure the flow of fuel within a second flow range. The first flow range comprises larger flows of fluid than the second flow range.

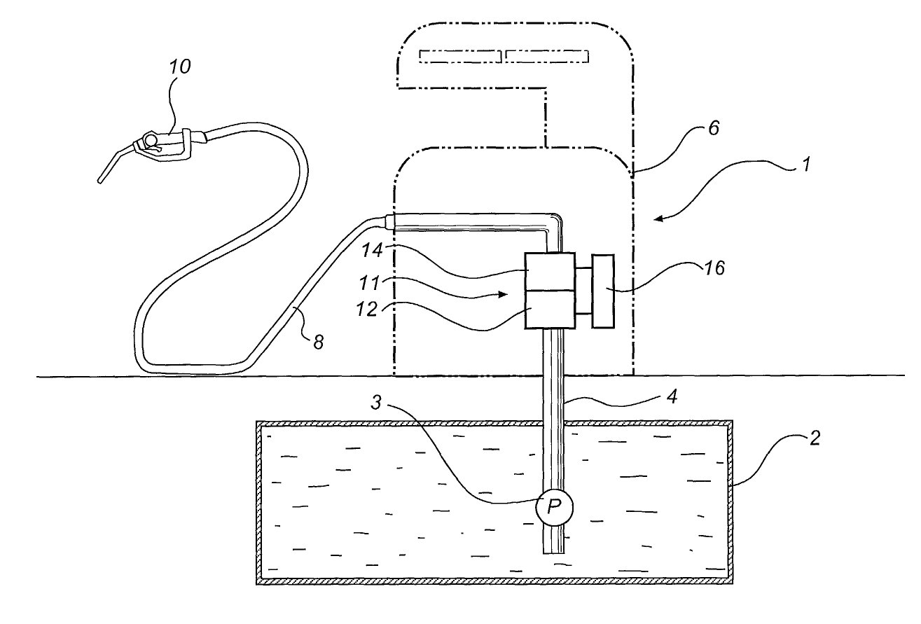

### FIELD OF THE INVENTION

The present invention relates to a fuel pump unit of the type stated in the preamble to appended claim 1. Moreover, the invention concerns a method for measuring a discharge of fuel from a fuel pump unit according to the preamble to appended claim 14.

### BACKGROUND ART

Petrol stations usually have a fuel pump unit comprising at least one fuel container, one delivery nozzle and at least one conduit connecting the fuel container with the delivery nozzle and containing a pump. A flow meter and an associated display are arranged in the fuel pump unit for measuring and presenting the fuel volume discharged by means of the pump through the delivery nozzle. Moreover, additional valves are usually arranged in the conduit to control the flow, such as a non-return valve, a pressure control valve and a delivery valve cooperating with the delivery nozzle.

Authorities and consumers place high demands on the accuracy of the equipment, i.e. that the delivered volume of the fuel pumps be correct. The assessment of the accuracy of a fuel pump is made by recording the deviation between the delivered volume measured by the metering means and the actually filled-up volume during filling-up or refuelling. The accuracy is usually recorded in three capacity ranges, viz. maximum capacity, a tenth of the maximum capacity and somewhere between these two capacities. The rigid accuracy requirements, usually ±0.5% during refuelling, imply that the metering means are usually calibrated once a year. In connection with the calibrations, defective metering means and any leakage during filling-up are taken care of.

In addition to the above-mentioned accuracy requirements during refuelling, fuel pumps must manage to present and record extremely small leakage flows between the filling operations. One difficulty is that most metering means manage merely a metering range of about 1:10, i.e. filling flow rates in, for instance, the ranges 4-40 l/ min or 8-80 l/min, although metering means having a greater metering range, such as 1:100, are available. In order to manage to measure both filling flows and small leakage flows it would, however, be necessary for the metering means to manage great metering ranges of up to about 1:10,000, which because of the expense is impossible in actual practice. A leakage can be devastating to the environment and expensive to the trader if it is not detected. Therefore even low flow rates, such as one centimeter per hour, should not escape being detected.

A well-tried technique in the field of metering means having great metering ranges, which satisfy the accuracy requirements in the filling operation, involves volumetric flow meters, such as displacement meters. Since the displacement meters are fitted for measuring high filling flow rates, only a small number of measuring points are obtained when detecting or measuring low leakage flow rates. This results in the measurement having unsatisfactory resolution and possibly yielding incorrect measured values in case of low leakage flow rates in the conduit. Alternatively, the leakage is so small that it is difficult for the displacement meter to record it. Moreover, displacement meters have a very complicated design involving a large number of components and movable parts, which results in expensive manufacture, leakage problems in connection with low flow rates and time-consuming calibration. Displacement meters fitted for filling flow rates also have a relatively large stagnant volume, which increases the risk of contamination when different kinds of fuel pass through the same metering means on different filling occasions. By stagnant volume is meant the liquid volume which is accommodated in the metering means between two filling occasions.

U.S. Pat. No. 5,325,706 discloses a fuel pump unit for detecting small flows in the event of leakage. The fuel pump unit comprises a fuel container with a pump which is adapted to feed fuel onto a conduit and a delivery nozzle. A metering means is arranged in the conduit to measure the volume of dispensed fuel, and an activating device is adapted to activate the pump in the filling operation. To detect a possible leakage, a filling operation is simulated by starting the pump while the delivery nozzle is closed. If the metering means detects a flow through the conduit during simulation, a leakage signal is generated. This technical solution still suffers from the above problems in detecting the low flow rates, for instance in connection with leakage. No value of the flow rate in case of leakage is obtained, merely an indication that a leakage occurs.

Since thousands of fuel pump units are manufactured each year, any improvement of the equipment and any simplification of its maintenance are incredibly important.

### SUMMARY OF THE INVENTION

An object of the invention is to provide a fuel pump unit which is improved in relation to prior-art and is adapted to measurements in great flow ranges.

A specific object of the invention is to provide, compared with prior-art, a simpler construction of the metering means included in the fuel pump unit.

A further object of the invention is to provide at the same time a fuel pump unit which has improved calibration possibilities.

A special object of the invention is to provide a fuel pump unit with improved detection and measurement of low flow rates, such as in case of leakage.

One more object of the invention is to provide a method, improved in relation to prior art, of measuring the flow of fuel in great flow ranges in a fuel pump unit.

According to the invention, these and other objects that will be evident from the following description are achieved by a fuel pump unit and a method which are of the type mentioned by way of introduction and which besides have the features stated in the characterising clause of claims 1 and 14, respectively.

According to the invention, use is made of a first and a second metering unit for measuring the fuel flow rate in the conduit. This means that the flow rate measurements can be made by means of metering units which each have a smaller metering range and, thus, a simpler construction than conventional metering means. The relatively simple construction of the metering units results in less expensive manufacture as well as easier and less time-consuming calibration.

Preferred embodiments of the fuel pump unit appear from the appended subclaims.

According to a preferred embodiment, the metering units are arranged in series in the same fuel conduit. This provides the possibility of measuring the actual flow rate in the fuel conduit by means of two flow ranges, which preferably partly overlap. No division of the flow by means of valves and conduit branches is required, as is the case, for instance, when connecting the metering units in parallel. This reduces the risk of leakage and difficulties in obtaining correct flow rate measurements. Moreover, the metering units can be connected to the fuel conduits of existing fuel pump units without making any significant constructional changes.

Any flow of fuel back to the fuel container when completing the filling operation is prevented preferably by a non-return valve function of one of the two metering units. This eliminates the need for a separate non-return valve in the fuel pump unit.

In one embodiment, both metering units have a measuring accuracy for the first and the second metering range which satisfies the stringent requirements made by authorities and consumers. This is facilitated since the total metering range has been divided into preferably two parts. An accuracy of about ±0.5%, preferably about ±0.25% and most advantageously about ±0.125% is achieved in the first metering range and advantageously also in the second metering range.

The flow range of the first metering unit is, according to a preferred embodiment, usually somewhere in the range of about 1-100 l/min, preferably 4-40 l/min. This makes it possible to carry out the filling operation in the first flow range with an acceptable flow rate and accuracy.

The flow range of the second metering unit has, in a preferred embodiment, an upper limit of at least about 1.5 l/min, preferably about 3 l/min and most advantageously 5 l/min. This means that measurements of small flows, for instance in leakage, can be detected and/or measured.

In a preferred embodiment, the first metering range comprises filling flow rates. The second metering range advantageously comprises leakage flow rates. The metering units can then be specifically adapted to the various flow rates and, consequently, yield improved measured values.

Preferably, the first metering unit is a flow meter, such as a turbine flow meter, an ultrasonic flow meter or a rotameter. It is possible to obtain great accuracy with a simple and robust metering unit since the total flow range has been divided into smaller ranges. Preferred flow meters have a small number of movable components, a simple construction and a small remaining fuel volume in the meter between the filling occasions.

The second metering unit advantageously is a flow meter, such as a turbine flow meter, an ultrasonic flow meter, or preferably a variable area flow meter. The variable area flow meter is suitable as the second metering unit since it may have a built-in non-return valve function.

In a preferred embodiment, a control unit is arranged in the fuel pump unit to control, based on the flow of fuel in the conduit, which of the metering units is to indicate the flow. As a result, the metering units can continuously measure the flow in the conduit. The control unit decides which of the metering ranges of the metering units best corresponds to the flow in the conduit and, thus, indicates the most correct measured value.

The method of measuring the flow is carried out by the fuel being made to flow through the fuel conduit in connection with, for instance, a dispensing operation or a leakage. The flow within a first flow range is measured by a first metering unit, and the flow within a second flow range is measured by a second metering unit. The two metering units produce great accuracy in a wide metering range since the two metering ranges of the metering units preferably partly overlap. On the basis of the flow rate in the conduit, a control unit decides which of the two metering units indicates a correct value of the flow rate.

### BRIEF DESCRIPTION OF THE DRAWING

The invention will now be described in more detail with reference to the accompanying drawing, which for the purpose exemplification illustrates a currently preferred embodiment of the inventive fuel pump unit.

### DESCRIPTION OF PREFERRED EMBODIMENTS

In a preferred embodiment of a fuel pump unit 1 according to the invention as shown in the drawing, a fuel container 2 is arranged to contain and supply fuel. From the fuel container 2 extends a fuel conduit 4 to the body 6 of the fuel pump unit 1. The fuel conduit 4 extends through the body 6 to a delivery hose. The delivery hose 8 is in turn connected to a delivery nozzle 10. A pump means 3 is arranged in connection with the fuel container 2 to produce a flow of fuel through the fuel conduit 4 in connection with the dispensing operation.

Two metering units 12, 14 with partly overlapping or neighbouring metering ranges are arranged in the fuel conduit 4 between the fuel container 2 and the delivery hose 8. The metering units 12, 14 continuously supply measured values of the flow in the conduit 4. A control unit 16 is connected to the metering units 12, 14 to decide which measured value best indicates the flow in the fuel conduit 4. The control unit 16, in the form of a central processing unit (CPU), bases the choice of metering unit 12, 14 on the rate of the flow of fuel. The metering unit 12, 14 whose metering range best corresponds to the flow rate in the conduit 4 is considered to indicate the flow rate in the conduit. The first metering range that is measured by the metering unit 14 relates to high flow rates, such as filling flow rates. The second metering range that is measured by the metering unit 12 relates to low flow rates, such as leakage.

When the flow rate in the conduit 4 exceeds the metering range of the second metering unit 12, this unit indicates its maximum value. Then the control unit 16 indicates that the actual flow rate is to be recorded from the first metering unit 14 since the flow rate is in the metering range of the first metering unit 14. In flow rates where the metering ranges overlap, the control unit 16 selects the metering unit 12, 14 depending on which metering range is considered to best correspond to the actual flow rate.

Furthermore the metering units 12, 14 are arranged in series in the fuel conduit 4 to measure the actual flow rate, i.e. without any intermediate branches of the conduit 4. The metering units 12, 14 are arranged so as not to influence each other's measurement results. The same flow passes through the two metering units 12, 14. All the fuel dispensed, passing the delivery nozzle, preferably always passes through the two metering units. The metering means preferably have a maximum stagnant volume of about 0.12 l to reduce the risk of contamination. Only small measures are necessary to install the metering units 12, 14 connected in series.

In the dispensing operation, the metering unit 14 obtains, for dispensing flow rates, an accuracy of about ±0.5%, preferably about ±0.25% and most advantageously about ±0.125%, in respect of the measured flow rates in the first flow range. The metering unit 14 is in the preferred embodiment a flow meter. By a flow meter is meant a meter which, in contrast to the above-mentioned displacement meter, measures the flow rate of fuel passing through the conduit, such as an ultrasonic flow meter, a variable area flow meter or most advantageously a turbine flow meter. A turbine flow meter has a small number of movable components and a small stagnant volume and is easy to calibrate. The turbine flow meter also measures the flow rate in the conduit with great accuracy in the flow ranges, for instance about 1-100 l/min, about 2-80 l/min or about 4-40 l/min.

In the preferred embodiment, the metering unit 12 for leakage flow rates preferably is a variable area flow meter but can also be some other type of flow meter, such as a turbine flow meter or an ultrasonic flow meter. In a variable area flow meter there moves a suspended body in dependence on the flow rate in the conduit, so that the flow rate can be calculated. Such a variable area flow meter can detect low flow rates through the conduit, for instance up to about 1.5 l/min. The metering unit 12 is advantageously designed to give measurement results with great accuracy in a flow range which extends up to at least 1.5 l/min, preferably up to at least about 3 l/min and most advantageously up to about 5 l/min. The accuracy requirements in connection with the measurement of leakage in the second metering range need not be as stringent as the requirements in the first metering range.

In the preferred embodiment involving a variable area flow meter 12, this comprises a tapering portion (not shown) upstream of the suspended body (not shown) to achieve close engagement between the suspended body and the conduit 4 when the fuel tends to flow back towards the fuel container 2. This eliminates, when connecting the metering units 12, 14 in series, the need for a separate non-return valve arranged in the conduit 4. A holding means (not shown), for instance in the form of pins or abutments, is arranged in the variable area flow meter 12 to prevent the suspended body from accompanying the fuel during refuelling.

According to an alternative embodiment of the invention, the control unit 16 controls the metering units 12, 14 to and from a measuring position at different flow rates through the conduit 4. For example, the metering unit 14 can be controlled to measure the flow rate in the conduit 4 during refuelling since the flow rate is then to be found in a range which is suitable for the metering unit 14, for instance 4-40 l/min, and the metering unit 12 can be controlled to measure the flow rate on other occasions when the flow rate is lower, for instance below 4 l/min.

It will be appreciated that a large number of modifications of the above embodiments of the invention are feasible within the scope of the invention as defined in the appended claims.

According to a further embodiment, the two metering units 12, 14 can be connected in parallel to measure the flow rate in the fuel pump unit 1. By arranging the metering units in a respective branch of the conduit, the flow can be directed to each of the metering units. The metering units can be connected in parallel without taking into consideration how the flow rate is affected by the respective metering units. In one of the branches of the conduit, high flow rates are measured within a first metering range, such as during refuelling. In the other of the branches of the conduit, low flow rates are measured within a second metering range, such as in leakage. A multiplex valve is arranged upstream of the branch of the conduit to direct the flow to the correct branch depending on the rate of the flow of fuel through the conduit. Metering units connected in parallel instead of in series are disadvantageous since they require more valves.

The two metering units 12, 14 could alternatively also be volume flow meters or mass flow meters, such as displacement meters or coriolis meters, and achieve many advantages according to the inventive idea of using two cooperating metering units.

In another embodiment, the metering ranges of the two metering units can be separated from each other or touch on each other. For instance, the metering range of the second metering unit can extend up to about 1 l/min, about 2 l/min or 4 l/min. Then the two metering ranges touch on each other and the choice of metering unit made by the control units is simplified. In this embodiment the two metering ranges touch on each other in a range that is not used in refuelling.

In a further embodiment, the metering units 12, 14 are arranged in a fuel conduit which in turn is connected to a plurality of fuel containers. The arrangement of a plurality of fuel containers makes it possible, in the dispensing operation, to mix fuel of different quality, for instance octane ratings. This is possible by the flow-controlling valves cooperating with the metering units 12, 14, which both measure with a great accuracy of about ±0.5%, preferably about ±0.25%. In order to obtain a correct mixing ratio, one more metering means with small accuracy can be arranged between one of the mixing containers and the metering units. Furthermore, it is advantageous to use a turbine flow meter in the dispensing operation from several fuel containers. Since turbine flow meters retain a smaller amount of fuel in the metering unit from a previous dispensing operation compared with, for instance, displacement meters, the risk of contamination decreases. The mixed fuel is then passed on to one or more delivery nozzles. Besides, only one set of metering units for a plurality of containers means that additional space can be saved.

It is obvious to a person skilled in the art that the succession of the first and the second metering unit in the conduit is not of any particular importance.

1. A fuel pump unit for dispensing fuel, comprising a fuel container (2),
a fuel conduit (4) connected to the fuel container (2),
a metering means (11) which is arranged in connection with the conduit (4) to measure a flow of fuel therethrough, characterised in that the metering means (11) comprises
a first metering unit (14) for measuring the flow of fuel within a first flow range, and
a second metering unit (12) for measuring the flow of fuel within a second flow range, the first flow range comprising larger flows of fluid than the second flow range.

2. A fuel pump unit according to claim 1, wherein the two metering units (12, 14) are arranged in series in the fuel conduit (4).

3. A fuel pump unit according to claim 1 or 2, wherein one of the metering units (12, 14) comprises a valve member with a non-return function.

4. A fuel pump unit according to any one of the preceding claims, wherein the first metering unit (14) has an accuracy of about ±0.5%, preferably about ±0.25% and most advantageously about ±0.125%, in respect of measured flows within the first flow range.

5. A fuel pump unit according to any one of the preceding claims, wherein the second metering unit (12) has an accuracy of about ±0.5%, preferably about ±0.25% and most advantageously about ±0.125%, in respect of measured flows within the second flow range.

6. A fuel pump unit according to any one of the preceding claims, wherein the first flow range comprises dispensing flows and the second range comprises leakage flows.

7. A fuel pump unit according to any one of the preceding claims, wherein the flow range of the first metering unit (14) has a lower limit of at least about 1 l/min, preferably at least about 4 l/min, and an upper limit of at most about 100 l/min, preferably at most about 40 l/min.

8. A fuel pump unit according to any one of the preceding claims, wherein the flow range of the second metering unit (12) has an upper limit of at least about 1.5 l/min, preferably at least about 3 l/min and most advantageously about 5 l/min.

9. A fuel pump unit according to any one of the preceding claims, wherein a pump means (3) is arranged in the conduit (4) to perform a discharge of fuel from the fuel container (2).

10. A fuel pump unit according to any one of the preceding claims, wherein the first metering unit (14) is a flow meter, such as a turbine flow meter, an ultrasonic flow meter or a rotameter.

11. A fuel pump unit according to any one of the preceding claims, wherein the second metering unit (12) is a flow meter, such as a turbine flow meter, an ultrasonic flow meter or preferably a variable area flow meter.

12. A fuel pump unit according to any one of the preceding claims, wherein a control unit (16) communicating with the metering units (12, 14) controls the choice of metering unit for flow reading in dependence on the rate of the flow of fuel.

13. A fuel pump unit according to any one of the preceding claims, wherein the same fuel flow passes through both metering units (12, 14).

14. A method of measuring a discharge of fuel from a fuel pump unit, characterised by the steps of
causing fuel to flow from a fuel container (12) to a fuel conduit (4),
measuring the flow within a first flow range by means of a first metering unit (14) arranged in connection with the conduit (4),
measuring the flow within a second flow range by means of a second metering unit (12) arranged in connection with the conduit (4), and
controlling the choice of metering unit for flow reading by means of a control unit (16) which is arranged in connection with the metering units (12, 14).

15. A method of measuring a discharge of fuel from a fuel pump unit according to claim 14, characterised by the steps of
selecting the first metering unit (14) by means of the control unit (16) to perform the flow measurement in connection with refuelling, and
selecting the second metering unit (12) by means of the control unit to perform the flow measurement on other occasions.
